(19) United States
(12) Patent Application Publication
(10) Pub. No.: US 2001/0012052 A1
(43) Pub. Date: Aug. 9, 2001

(54) Information system comprising interactive multimedia information stations networked with a videophone call centre

(75) Inventor: Laurent Chevillard, Issou (FR)

Correspondence Address: YOUNG & THOMPSON, 745 SOUTH 23RD STREET 2ND FLOOR, ARLINGTON, VA, 22202

(73) Assignee: FRANCE TELECOM

(21) Appl. No.: 09/779,742

(22) Filed: Feb. 9, 2001

(30) Foreign Application Priority Data
Feb. 9, 2000 (FR) 00 01606

(51) Int. Cl. H04N 7/14

(52) U.S. Cl. 348/14.01

(57) ABSTRACT

Information system comprising an assembly of at least one information station (100₁, . . . , 100ₙ) which possesses data storage means and means of interaction with at least one user, by exchange of information such as sounds and/or pictures and/or alphanumeric data so as to provide the user with information extracted from the said storage means.

Furthermore, the information system comprises a videophone call center (200) connected to the said station (100ᵢ) by means of a high bit rate communication network (300) and the said station possesses means, actuatable by the user, for establishing a videophone communication with a terminal so as to enter into communication with an operator holding the information sought by the user.

The present invention relates to an information system comprising an assembly of at least one information station which possesses data storage means and means of interaction with at least one user, by exchange of information such as sounds and/or pictures and/or alphanumeric data so as to provide the user with information extracted from the said storage means.

For example, and in particular in advertising information systems, the information stations are disposed on a sales site. Today, when dealing with stations comprising a personal computer, such stations contain information on products and/or services, which is stored in memory on a hard disk or on a CD-ROM type support. They each interact with a user by exchanging multimedia information, that is to say information such as sounds, pictures and/or alphanumeric data, by way of a man/machine interface so as to provide the user with information which they contain.

When the information contained in an information station is not sufficient to satisfy a user, on a particular product and/or service, the local presence of a relevant product and/or service specialist becomes necessary.

This results either in a high cost of the information system, due to the permanent presence of specialists on the sales sites, or to the nonsatisfaction of users when the information provided to them is incomplete.

The invention aims to remedy the drawbacks of the conventional information systems by creating an information system which does not require the presence of specialists on the sales sites, and is therefore cheaper than the conventional systems.

The subject of the invention is therefore an information system comprising an assembly of at least one information station which possesses data storage means and means of interaction with at least one user, by exchange of information such as sounds and/or pictures and/or alphanumeric data so as to provide the user with information extracted from the said storage means, characterized in that it furthermore comprises at least one videophone call centre connected to the said station by means of a high bit rate communication network and in that the said station possesses means, actuatable by the user, for establishing a videophone communication with a terminal so as to enter into communication with an operator holding the information sought by the user.

This information system thereby enables a user of an information station to obtain complete information on a product and/or service by access to the information contained locally in the station and possibly by obtaining supplementary information by virtue of the establishing, at his request, of a videophone communication with an operator, who is a specialist in the said product and/or service.

The information system according to the invention can also comprise one or more of the following characteristics:

the means for establishing a videophone communication comprise means for generating a signal destined for the call centre, containing specific information on the said station, on a user, on a product and/or a service;

the information system comprises means for selecting an operator as a function of the said specific information;

the information system comprises a driver server which comprises means for storing data pertaining to the operators, the selection means being integrated with the driver server and carrying out the selection of an operator as a function of the said data and of the said specific information;

the said storage means comprise an array comprising in each row the address of an operator terminal, information regarding the status of the terminal, the said data, and the selection means comprise means for calculating a correlation function between the said data and the said specific information;

the driver server comprises an algorithm for automatically checking the status of each terminal adapted so as to perform successive checks of the state of parameters chosen from among administrative constraint information, the state of the videophone link of the terminal with a corresponding station and the state of the connection of the terminal to the local network;

the information system furthermore comprises a server attached to the station by means of a communication network and intended for the downloading of information such as sounds and/or pictures and/or alphanumeric data, into the storage means of the station;

the information system comprises a database server containing information such as sounds and/or pictures and/or alphanumeric data, the server being accessible by any terminal of the videophone call centre and adapted for exchanging information relating to products and/or services and/or to a user and/or to an operator;

the station comprises a device with button for actuating the said means so as to establish a videophone communication;

the station comprises a touch screen, part of which constitutes the said actuation device; and

the information system constitutes a private network of Intranet type, in particular a secure network.

The subject of the invention is also an information station for an information system as defined above, possessing data storage means and means of interaction with a user, by exchange of information such as sounds and/or pictures and/or alphanumeric data so as to provide the user with information extracted from the said storage means, characterized in that the said station is furnished with means of connection to the high bit rate communication network and possesses means for establishing a videophone communication with an operator.

Another subject of the invention is a process for exchanging information such as sounds and/or pictures and/or alphanumeric data with an information station of an information system, which station possesses data storage means and means of interaction with at least one user, so as to provide the user with information extracted from the said storage means, characterized in that it comprises the steps of

sending by the station to a driver server of a request for establishing a videophone communication;

sending by the driver server to the station of a signal containing the address of an available terminal of a videophone call centre;

modification of a status, in an array of variables of the driver server which are representative of the availability of each terminal, from an available state to an unavailable state of the selected terminal;

sending by the station to the selected terminal of a request for establishing a videophone communication;

establishment of a videophone communication between the station and the selected terminal;

sending by the selected terminal to the station of a request for information stored by the station; and

sending by the selected terminal to a database server of a request for information stored by the server.

The invention will be better understood with the aid of the description which follows, given merely by way of example whilst referring to the appended drawings in which:

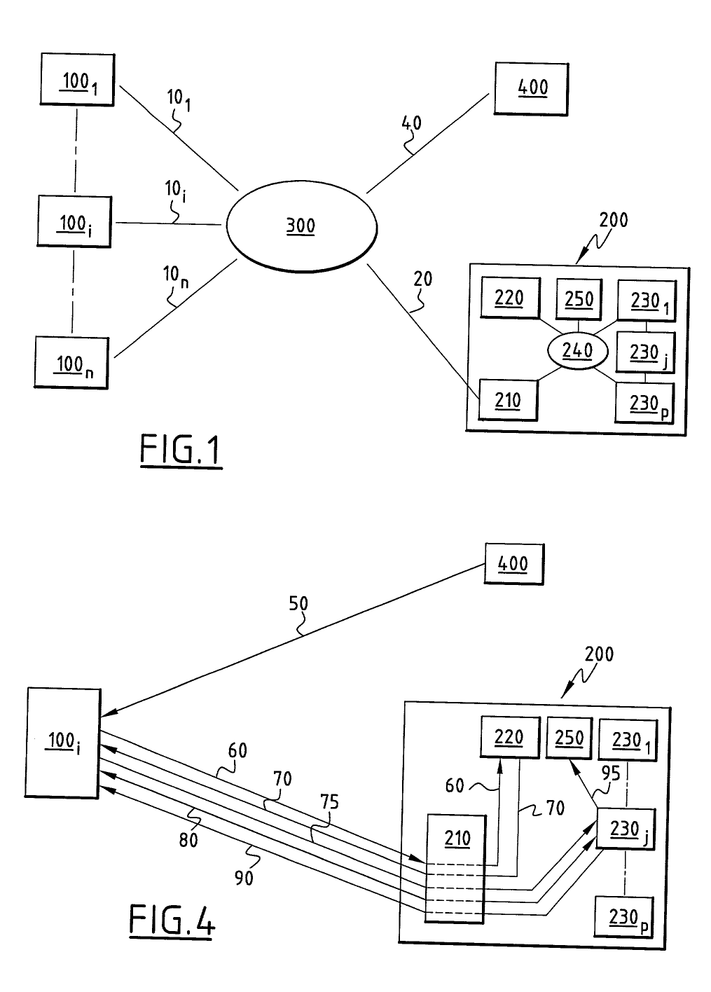

FIG. 1 is a diagram illustrating the general structure of an advertising information system according to the invention;

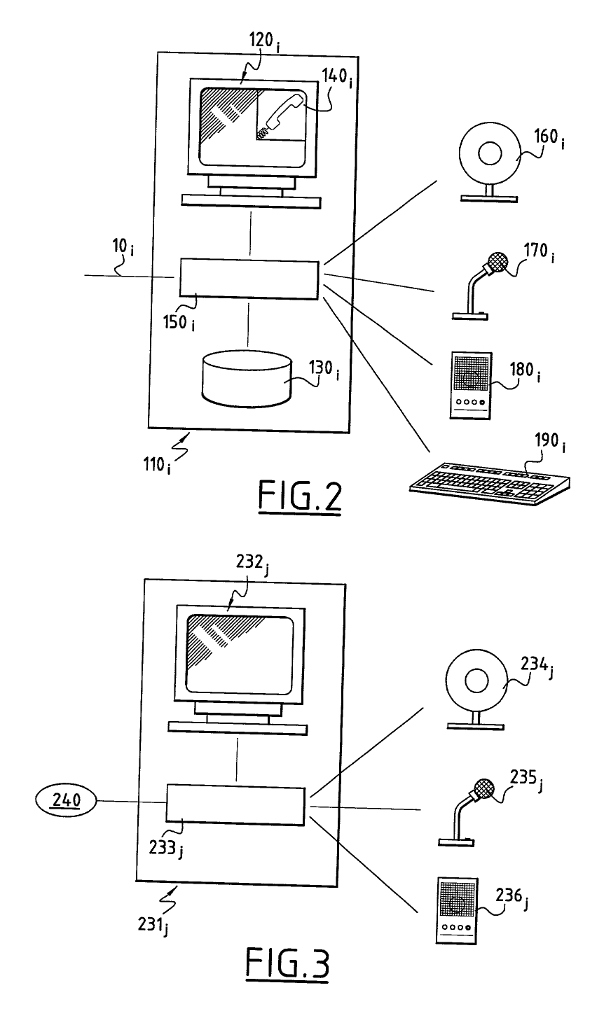

FIG. 2 represents a diagram detailing the makeup of a station of the information system of FIG. 1;

FIG. 3 represents a diagram detailing the makeup of a terminal of the videophone call centre of the advertising information system of FIG. 1;

FIG. 4 represents a diagram showing the exchanges of information between the elements of an advertising information system according to the invention; and

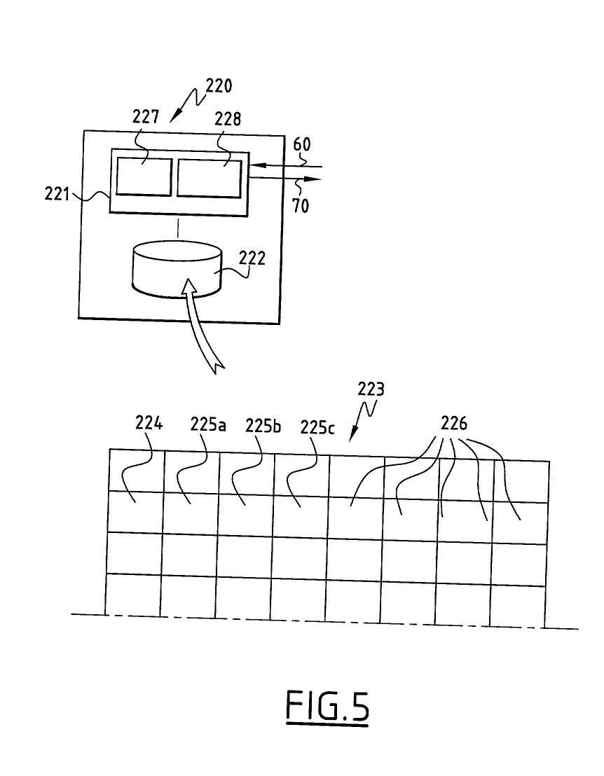

FIG. 5 represents a diagram detailing the makeup of the driver server of the videophone call centre of FIG. 3.

Represented diagrammatically in FIGS. 1 to 5 is the structure of an advertising system in accordance with the invention. It is however appreciated that the invention applies equally, generally, to any type of information system.

The advertising information system represented in FIG. 1 comprises an assembly {100₁; . . . ; 100ₙ} of advertising stations situated for example on so many sales sites and a videophone call centre 200 to which the stations are connected by means of a high bit rate communication network 300. The network 300 is for example an asynchronous transfer mode network, conventionally referred to as an ATM network.

Access from any advertising station 100ᵢ to the network 300, for its part, is ensured by an access network forming a link 10ᵢ capable of supporting high bit rate communications, so as to be able to transmit a videophone communication whose bit rate is conventionally between several tens of kilobits per second and 2 megabits per second. A link 10ᵢ of the digital leased link type employing asymmetric or symmetric transmission, conventionally referred to as an Xdsl link (Asymmetric or Symmetric Digital Subscriber Line), is suitable for effecting this access, given that the Xdsl technology known today makes it possible to send at a bit rate of at least 1 megabit per second to the network and to receive at a higher bit rate in the other direction.

Access from the videophone call centre to the network 300 is, for its part, ensured by a high bit rate link 20 of ATM type. The videophone call centre comprises a switch 210 using the Internet Protocol for communication, conventionally referred to as an IP switch, driven by a driver server 220 to which it is attached by means of a local network 240. This network is adapted for supporting high bit rates so as to be able to establish a videophone communication. To do this, it is constructed under Ethernet 100 base T technology. Of course, the switch 210 is adapted to the bit rates requested and to the types of information to be switched.

An assembly {230₁; . . . ; 230ₚ} of terminals of the call centre, to each of which an operator is assigned, is attached to the switch 210 by the local network 240. Each terminal 230ⱼ comprises a personal computer equipped with a local network card for connecting it to the local network 240 and enabling it to access a database server 250 of the call centre.

A function of the server 250 is to store information such as sounds, pictures and/or alphanumeric data relating on the one hand to products and/or services, on the other hand to users of the assembly of stations and their requests, transmitted to the call centre during videophone communications. This information can be accessed at any moment by the operators. It enables the server 250 to keep databases up to date, in particular user databases adapted for the triggering by the server of orders, payments, deliveries.

Finally, the system comprises a downloading server 400, connected to the assembly {100₁; . . . ; 100ₙ} of advertising stations by means of the network 300 and by way of a conventional link 40. A function of the downloading server 400 is to update the information such as sounds, pictures and/or alphanumeric data stored on the hard disk of any advertising station 100ᵢ, when the latter is not operated by a user, for example at night. The downloading is done by using the File Transfer Protocol, conventionally referred to as the FTP protocol.

The information system described hereinabove constitutes, for example, a private network of Intranet type, possibly a secure network, allowing the editing and sharing of files, as well as communications between various elements of the system, in the form of sounds, pictures and/or alphanumeric data. The system can furthermore comprise gateways for access to Internet and/or other Intranets.

With reference to FIG. 2, any station 100ᵢ of the system comprises a server computer 110ᵢ comprising, in particular, a touch screen 120ᵢ and a hard disk 130ᵢ. The hard disk 130ᵢ has a capacity of several gigabytes for storing information such as sounds, pictures and/or alphanumeric data. A part 140ᵢ of the touch screen 120ᵢ, which can be actuated by simple pressure from the user, constitutes the device for actuation of the means so as to establish a videophone communication, which means comprise means for generating a signal 60 and a signal 80 which will be described hereinbelow, with reference to FIG. 4. The station also comprises input means 190ᵢ enabling the user to enter information intended to be stored on the hard disk of the station. These means comprise a keypad, a barcode reader and a payment card reader.

As may be seen in FIG. 3, any terminal 230ⱼ of the videophone call centre comprises a personal computer 231ⱼ comprising in particular a screen 232ⱼ.

Finally, with reference to FIGS. 2 and 3, the system is supplemented with videophone communication means 150ⱼ and 233ⱼ installed respectively in each station and in each terminal of the videophone call centre, for example in the form of videophony software of conventional type appropriate for the use envisaged. To these videophone communication means are attached, in each station as well as in each terminal, a camera, 160ᵢ and 234ⱼ respectively, a mike, 170ᵢ and 235ⱼ respectively and a loudspeaker, 180ᵢ and 236ⱼ respectively.

The manner of operation of the advertising system just described will now be described with reference to FIG. 4.

Firstly, when the system is quiescent, for example at night, the station connects up to the downloading server 400. By generating a signal 50, the latter updates, by replacing and/or adding files, the information such as sounds, pictures and/or alphanumeric data which are stored in the hard disk of the station.

During operation, a user in search of local information on a product and/or a service, firstly has the possibility of accessing the information contained in the hard disk of the station 100ᵢ, which information can be accessed by the user in the form of multimedia presentation pages, so as to obtain directly the information relating to the product and/or service. Access to this information is effected by operating the station by means of the touch screen and/or, as appropriate, by reading a barcode by means of an appropriate reader. Moreover, the user can chose a preferred language of communication with the station, from among a list displayed on the screen. He can also input other information by virtue of the input means 190ᵢ, such as his name, his electronic mail address, his postal address, etc.

When a user wishes to obtain more information relating to a selected product and/or service, than that extracted locally from the hard disk and the server functions of the station, if he so desires, he can enter into communication with an operator of the call centre so as to obtain supplementary information.

To do this, he actuates means for generating a signal 60 by pressure on a dedicated part 140ᵢ of the touch screen of the station. The signal 60 formulated thereupon by the generating means is representative of the information on the identification of the station 100ᵢ, the language of communication preferred by the user, a product and/or a service selected by the user, and more generally, any other information on the station, on the user and his requirement. The signal is transmitted by the IP protocol to the server 220, via the switch 210 of the call centre.

After a processing which will be detailed hereinbelow, the driver server 220 transmits, in response to the signal 60, a signal 70 destined for the station 100ᵢ, comprising the IP address of a terminal 230ⱼ selected as a function in particular of the information transmitted by the signal 60. The station then establishes a videophone communication 80 with the terminal 230ⱼ, after reception by the latter of a connection establishment request signal 75 sent by the station. Finally, during the videophone communication, the terminal 230ⱼ can transmit a signal 90 to the station 100ᵢ, so as to gather on the latter, the information transmitted by the signal 60 and/or that gathered by the input means 190ᵢ on the user, before the videophone communication request, and stored on the hard disk of the station. It can also transmit a request 95 to the server 250, which request contains at least some of the information which it has gathered, so as to receive, on a separate window from that used for the videophony and also displayed on its screen, supplementary information stored in the server 250.

This information can be displayed on the screen on the terminal 230ⱼ so that it is presented to the operator, during the videophone communication.

The videophone communication is interrupted by the operator when the latter hangs up.

The driver server 220 of the system represented in FIG. 5 comprises a calculating unit 221 attached to a database 222 which stores data pertaining to the operators in the form of an array 223. Each row of the array comprises several fields corresponding to the number of columns of the array.

The first field 224 comprises the IP address of an operator terminal 230ⱼ.

The following three fields 225a, 225b and 225c comprise information regarding the status of the terminal. The field 225a comprises administrative constraint information. The field 225b characterizes the state of the videophone link of the terminal with a corresponding station: this field is set to 1 if the terminal is engaged in a videophone communication, to 0 otherwise. The field 225c characterizes the state of the connection of the terminal to the local network 240: this field is set to 1 if the terminal is connected to the local network, to 0 otherwise.

The following fields 226 comprise the various characteristics to which the operator of the terminal 230ⱼ can respond. Each field is set to 1 if the terminal takes the characteristic on board, to 0 otherwise. The characteristics comprise for example the language(s) spoken by the operator, the origin of the call, the products and/or services relevant to the call. The fields 226 therefore comprise the following characteristics: “French”, “English”, “German”, “product A”, “service N”, etc.

The calculating unit 221 comprises on the one hand an algorithm 227 for automatically checking the status of each terminal, on the other hand means of selection 228 of a terminal.

The algorithm 227 is executed periodically. It possesses means for checking the state of operating parameters of the system, and in particular the state of the videophone link, the state of the connection to the local network of each terminal, as well as administrative constraints which are not described here. It allows periodic updating of the fields 225a, 225b and 225c of the array 223.

The selection means 228 receive the signal 60 as input. The signal 60 comprises information whose characteristics are to be found among those of the fields 226 of the array 223. After receipt of this signal, the information which it contains is compared with the fields 226, for the addresses 224 of the terminals 230ⱼ deemed to be available. The availability of a terminal may be the outcome of a logical operation, not described here since it is regarded as conventional, pertaining to the fields 225a, 225b and 225c of the array 223. The result of the comparison is the address of a terminal deemed to be in the available state and all of the characteristics of whose fields 226 corresponding to the information transmitted by the signal 60 are in the true state (i.e., the corresponding fields are set to 1). Conventional methods for sorting and for requesting in databases make it possible to execute these operations and are therefore not described here.

At output, the selection means set the field 225b of the selected terminal to 1 and transmit a signal 80 containing the IP address of this terminal to the station 100ᵢ.

It is clearly apparent that the advertising information system according to the invention, not requiring the presence of specialists in the sales sites, remedies the drawbacks of the conventional advertising systems.

Another advantage of the advertising information system according to the invention lies in its flexibility of use, its speed, and its autonomy, such a system being capable of providing accurate information on a product and/or on a service at the request of a user.

Another advantage of the advertising information system, when it furthermore comprises a downloading server, lies in its effectiveness in rapidly and simultaneously disseminating information on a product and/or a service, in particular when the latter is launched on all the sales sites in which the stations 100ᵢ are situated, these stations being regularly updated by the downloading system.

The human resources required are also optimized, in so far as they are centralized and common for various points of sale.

Finally, an advantage of the advertising information system according to the invention lies in the possibility which it offers of training and informing salespeople situated on the sales sites, when a product and/or a service is launched.

An application of an advertising information system according to the invention is the locating of numerous advertising and commercial stations, with unrestricted consultation, on the various sites of presence of a commercial entity.

Finally, it will be noted that the invention is not limited to the embodiment described.

In particular, as a variant, the switch 210 can be a private ATM switch, in which case the local network 240 is a combination of a network employing Ethernet 100 base T technology and a network of the ATM type.

Likewise as a variant, the information system can furthermore comprise an administrative server for the network 240 offering information on the general operation of the system and the administrative constraints 225a.

1. Information system comprising an assembly of at least one information station (100₁, . . . , 100ₙ) which possesses data storage means (130ᵢ) and means of interaction with at least one user, by exchange of information such as sounds and/or pictures and/or alphanumeric data so as to provide the user with information extracted from the said storage means, characterized in that it furthermore comprises at least one videophone call centre (200) comprising a plurality of terminals (200₁, . . . , 230ₚ) to each of which an operator is assigned, the videophone call centre (200) being connected to the said station (100ᵢ) by means of a high bit rate communication network (300) and in that the said station possesses means, actuatable by the user, for establishing a videophone communication with a terminal (230ⱼ) of the videophone call centre so as to enter into communication with the operator assigned to the said terminal and holding the information sought by the user.

2. Information system according to claim 1, characterized in that the means for establishing a videophone communication comprise means for generating a signal (60) destined for the call centre (200), containing specific information on the said station (100ᵢ), on a user, on a product and/or a service.

3. Information system according to claim 2, characterized in that it comprises means for selecting an operator as a function of the said specific information.

4. Information system according to claim 3, characterized in that it comprises a driver server (220) which comprises means (222) for storing data pertaining to the operators, the selection means being integrated with the driver server and carrying out the selection of an operator as a function of the said data and of the said specific information.

5. Information system according to claim 4, characterized in that the said storage means comprise an array (223) comprising in each row the address (224) of an operator terminal, information (225a, 225b, 225c) regarding the status of the terminal, the said data (226), and in that the selection means comprise means for calculating a correlation function between the said data and the said specific information.

6. Information system according to claim 4, characterized in that the driver server comprises an algorithm (227) for automatically checking the status of each terminal adapted so as to perform successive checks of the state of parameters chosen from among administrative constraint information (225a), the state of the videophone link (225b) of the terminal with a corresponding station and the state of the connection (225c) of the terminal to the local network.

7. Information system according to claim 1, characterized in that it furthermore comprises a server (400) attached to the station by means of a communication network and intended for the downloading of information such as sounds and/or pictures and/or alphanumeric data, into the storage means (130ᵢ) of the station (100ᵢ).

8. Information system according to claim 1, characterized in that it comprises a database server (250) containing information such as sounds and/or pictures and/or alphanumeric data, the server being accessible by any terminal of the videophone call centre and adapted for exchanging information relating to products and/or services and/or to a user and/or to an operator.

9. Information system according to claim 1, characterized in that the station (100ᵢ) comprises a device with button for actuating the said means so as to establish a videophone communication.

10. Information system according to claim 9, characterized in that the station comprises a touch screen (120ᵢ), part (180ᵢ) of which constitutes the said actuation device.

11. Information system according to claim 1, characterized in that it constitutes a private network of Intranet type, in particular a secure network.

12. Information station for an information system in accordance with one of claims 1 to 11, possessing data storage means and means of interaction with a user, by exchange of information such as sounds and/or pictures and/or alphanumeric data so as to provide the user with information extracted from the said storage means, characterized in that the said station is furnished with means (10ᵢ) of connection to the high bit rate communication network (300) and possesses means for establishing a videophone communication with an operator.

13. Process for exchanging information such as sounds and/or pictures and/or alphanumeric data with an information station (100ᵢ) of an information system, which station possesses data storage means and means of interaction with at least one user, so as to provide the user with information extracted from the said storage means, characterized in that it comprises the steps of
sending by the station to a driver server (220) of a request (60) for establishing a videophone communication;
sending by the driver server to the station of a signal (70) containing the address of an available terminal (230ⱼ) of a videophone call centre;
modification of a status (225b), in an array of variables of the driver server which are representative of the availability of each terminal, from an available state to an unavailable state of the selected terminal;
sending by the station to the selected terminal of a request (75) for establishing a videophone communication;
establishment of a videophone communication (80) between the station and the selected terminal;
sending by the selected terminal to the station of a request (90) for information stored by the station; and
sending by the selected terminal to a database server (250) of a request (95) for information stored by the server.
